(19) United States
(12) Patent Application Publication
(10) Pub. No.: US 2010/0104115 A1
(43) Pub. Date: Apr. 29, 2010

(54) MICRO MAGNETIC SPEAKER DEVICE WITH BALANCED MEMBRANE

(75) Inventors: Jun Zheng, Edina, MN (US); Dadi Setiadi, Edina, MN (US); Haiwen Xi, Prior Lake, MN (US); Insik Jin, Eagan, MN (US); Nurul Amin, Woodbury, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/361,905

(22) Filed: Jan. 29, 2009

Related U.S. Application Data
(60) Provisional application No. 61/109,200, filed on Oct. 29, 2008.

(51) Int. Cl. H04R 25/00; H04R 1/00

(52) U.S. Cl. 381/182; 381/412

(57) ABSTRACT

A micro magnetic device with a micro magnetic speaker unit having a first element, a second element, and a membrane therebetween. Each of the elements comprises a body, a pole of soft magnetic material, an electrically conductive coil positioned around the pole, and a permanent magnet connected to the membrane. The first element and the second element are magnetically identical. A plurality of speaker units can be combined to provide a speaker array.

### RELATED APPLICATIONS

This application claims priority to U.S. provisional patent application No. 61/109,200, filed on Oct. 29, 2008 and titled “Monolithic Micro Magnetic Actuator (Array) Element with Balanced Membrane”. The entire disclosure of application No. 61/109,200 is incorporated herein by reference.

### BACKGROUND

Speakers are acoustical elements that are common is today's society. Speakers are present in radios, stereo systems, televisions, computers, earphones/headphones and other personal equipment that is configured to emit sound.

A traditional speaker (also referred to as a loud speaker or variation thereof) has a large magnet in close proximity to a movable current coil which drives a cone/diaphragm. The oscillating cone/diaphragm generates sound. Attempts have been made to miniaturize speakers, particularly for hearing aid applications. Although low cost and good reproducibility of electronic circuitry has been obtained, the number of realized miniature loudspeakers is small and these loudspeakers generally do not fulfill the requirements for a hearing instrument such as headphone or earphones. Traditional hearing aid speakers or receivers have a size usually ranging from 4 mm to 7 mm. Their cost increases 20-40% for every 1 mm decrease in size. Better micro-speakers and methods of making them are needed.

### BRIEF SUMMARY

The present disclosure is directed to micro magnetic devices (e.g., micro-speakers) having a membrane balanced between two elements. The micro magnetic device is suitable for use with, for example, hearing aid devices. The micro magnetic devices can be made by batch microfabrication processing using thin film or micro-electromechanical system (MEMS) techniques.

In one exemplary embodiment, this disclosure provides a micro magnetic device with a micro magnetic speaker unit having a first element, a second element, and a membrane therebetween. Each of the elements comprises a body, a pole of soft magnetic material, an electrically conductive coil positioned around the pole, and a permanent magnet connected to the membrane. The first element and the second element are magnetically identical.

In another exemplary embodiment, this disclosure provides a micro speaker array having a plurality of micro magnetic speaker units and a membrane. Each speaker unit has a first element and a second element, with the membrane therebetween. Each of the elements comprises a body, a pole of soft magnetic material, an electrically conductive coil positioned around the pole, and a permanent magnet connected to the membrane.

These and various other features and advantages will be apparent from a reading of the following detailed description.

### BRIEF DESCRIPTION OF THE DRAWING

The invention may be more completely understood in consideration of the following detailed description of various embodiments of the invention in connection with the accompanying drawing, in which:

FIG. 1 is a schematic side view of a micro magnetic speaker unit;

FIG. 2 is a schematic cross-sectional view of a micro magnetic speaker unit taken along line 2-2 of FIG. 1;

FIG. 3 is a schematic side view of an alternate embodiment of a micro magnetic speaker unit;

FIG. 4 is a schematic side view of an array of micro magnetic speaker units, in this embodiment, two units;

FIG. 5 is an exploded view of half of an array of micro magnetic devices according to this disclosure;

FIGS. 6A-6D are schematic side views of process steps for making a first part of an element of a micro magnetic unit;

FIGS. 7A-7E are schematic side views of process steps for making a second part of the element of a micro magnetic unit;

FIG. 8 is a schematic side view of a process step for combining the first part of the element of FIGS. 6A-6D with the second part of the element of FIGS. 7A-7E to form an element of a micro magnetic unit; and

FIG. 9 is a schematic side view of a micro magnetic unit formed by combining the element of FIG. 8 with another identical element.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present invention. The following detailed description, therefore, is not to be taken in a limiting sense.

The present disclosure is directed to miniaturized, micro magnetic devices such as micro-speakers. The elements can be used in high performance speaker devices, such as hearing aid devices, headphone or earphone devices. The micro magnetic devices according to the disclosure are intended for placement within or proximate the ear of a human being. However, the applications for the micro magnetic devices are not limited to entertainment or other audible uses, but can also include applications above that audible by humans (i.e., above about 20 kHz) such as military, biomedical and marine uses.

The present disclosure provides a micro magnetic speaker unit composed of a first speaker module or element, a second speaker module or element, and a membrane therebetween, wherein the first module and the second module are magnetically identical. Each of the modules has a body, a pole made of soft magnetic material, an electrically conductive coil positioned around the pole, and a permanent magnet connected to the membrane. In some embodiments, the first module and the second module are structurally identical and/or metallurgically identical. The body of each speaker module may have at least one unbounded side, such as two unbounded opposite sides.

The present disclosure also provides a micro magnetic speaker unit composed of a first element and a second element. The first element includes a first body having two opposite unbounded sides and two opposite walled sides, a first pole positioned between the unbounded sides and the walled sides, a first electrically conductive coil positioned around the first pole, and a first permanent magnet spaced from the first pole. The second element includes a second body having two opposite unbounded sides and two opposite walled sides, a second pole positioned between the unbounded sides and the walled sides, a second electrically conductive coil positioned around the second pole, and a second permanent magnet spaced from the second pole. A membrane extends between the first element and the second element, the membrane supporting the first magnet on a first side and supporting the second magnet on a second side. The first element and the second element may be magnetically identical, structurally identically, and/or metallurgically identical.

Various other micro magnetic speaker units are also provided by this disclosure. Any of the speaker units may be formed into an array. For example, this disclosure provides a micro speaker array comprising a plurality of micro magnetic speaker units and a membrane. Each unit has a first element and a second element, with the membrane therebetween.

The micro magnetic devices of this disclosure are built using microfabrication technology (e.g., thin film or micro-electro-mechanical (MEMS) techniques). An array of micro magnetic devices can be built simultaneously. While the present invention is not so limited, an appreciation of various aspects of the invention will be gained through the discussion provided below.

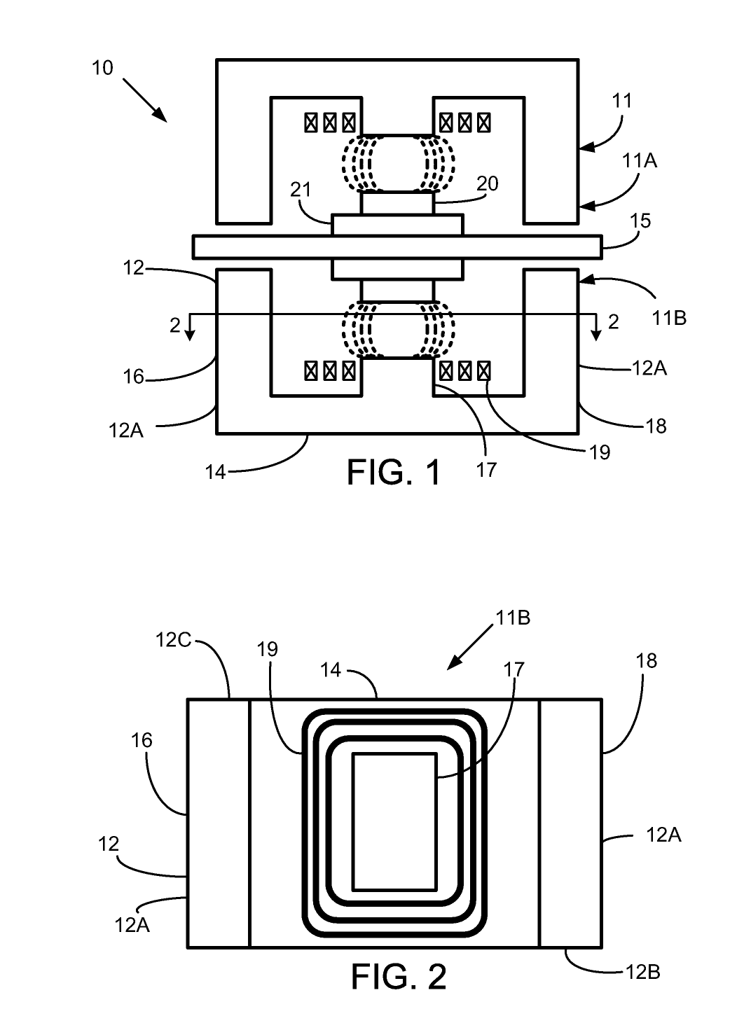

A first embodiment of a micro magnetic device is illustrated in FIG. 1 as micro-speaker unit 10. Micro-speaker unit 10 has two magnetically identical speaker modules or elements 11, specifically, a first top or upper speaker module or element 11A and a second lower speaker module or element 11B with an oscillateable membrane 15 positioned therebetween. The two magnetically identical modules 11A, 11B provide the symmetric and balanced unit 10. It should be noted that the designations of “top”, “upper”, “lower”, “bottom” and other such relative terms are only used for convenience herein and any unit structure with the discussed relative construction is within the scope of this invention.

FIG. 2 is a top view of a portion of module 11B. The following discussion is applicable to each module 11 (i.e., module 11A and module 11B), as the two elements are magnetically and structurally identical in this embodiment. In other embodiments, the two elements (i.e., module 11A and module 11B) utilize the identical materials, so that the two elements are magnetically, structurally and metallurgically identical.

Each module 11 has a body 12 that forms the overall shape of module 11; body 12 has opposite side edges 12A, front edge 12B and back edge 12C. Body 12 has a base portion 14 with a first wall 16 opposite a second wall 18 extending from base portion 14. Walls 16, 18 are positioned proximate side edges 12A of body 12 and are parallel to each other. In the illustrated embodiment, best seen in FIG. 2, walls 16, 18 extend the entire depth of body 12 and base 14, from front edge 12B to back edge 12C; in alternate embodiments, walls 16, 18 extend short of front edge 12B and/or back edge 12C. Each of front edge 12B and back edge 12C is unbounded; that is, front edge 12B and front edge 12C do not have a wall or other wall-type feature extending up from base 14. Centrally between walls 16, 18 is a pole 17. Around pole 17 on base 14 is an electrically conducting coil 19.

Body 12 is a soft magnetic material, optionally with high momentum, the magnetization of which can be altered by being exposed to a magnetic field. Examples of soft magnetic materials include ferromagnetic materials such as nickel (Ni), iron (Fe), cobalt (Co), iron oxide (Fe₂O₃), and combinations thereof. NiFe is one suitable material for body 12. The soft magnetic material forms base 14 and walls 16, 18. Typically, the same soft magnetic material forms base 14 and walls 16, 18, although not required. Pole 17, between walls 16, 18, is also of a soft magnetic material, optionally with high momentum, the magnetization of which can be altered by being exposed to a magnetic field. Typically, the same soft magnetic material forms pole 17 and walls 16, 18, although not required.

Electrically conducting coil 19, positioned around pole 17, is formed from an electrically conducting material, typically metal. Examples of suitable metals for coil 19 include copper (Cu), aluminum (Al), silver (Ag) and gold (Au). In FIGS. 1 and 2, coil 19 is illustrated as being a single layer with three turns; other designs for a coil may be useful, such as more or less turns, or multiple layers. Coil 19 may have, for example, from one to 100 (one hundred) turns around pole 17.

Seen in FIG. 1, spaced from body 12 and preferably centered over pole 17 is a magnet 20. Magnet 20 is supported by membrane 15 and moveable in relation to pole 17, specifically toward and away from pole 17. In some embodiments, positioned between membrane 15 and magnet 20 is an intermediate spacer element 21, which indirectly connects magnet 20 to membrane 15.

Membrane 15 is a flexible material, one that can be oscillated during use of unit 10. In most embodiments, membrane 15 is non-magnetic. Examples of suitable materials for membrane 15 include silicon (Si), dielectric material (for example, a polyamide or polyimide material), a metallic foil (for example, foils of NiCr, Al, W, Nb and Ta), or other semiconductor material.

Magnet 20 is a hard or permanent magnet, the magnetization orientation of which does not change. Examples of permanent magnet materials include iron (Fe), chromium (Cr), cobalt (Co), nickel (Ni), platinum (Pt), vanadium (V), manganese (Mn), bismuth (Bi), and combinations thereof. The material for magnet 20 may be a permalloy. Additionally, magnet 20 may be made of bulk material or may be electrochemical deposited (e.g., plated).

Intermediate spacer element 21 may be any of a hard or permanent magnet, a soft magnet, or a non-magnetic material (e.g., a non-magnetic metal, a polymer, a dielectric material, an insulating material, or any other non-magnetic material). In some embodiments, however, intermediate spacer element 21 is a soft magnetic material, and may be the same material as body 12 (e.g., NiFe).

As indicated above, unit 10 has first module 11A and second module 11B, which are magnetically identical, and in some embodiments also structurally identical, and/or metallurgically identical, and which are separated by membrane 15. In most embodiments, micro-speaker unit 10 and other micro magnetic devices of this disclosure, such as those described below, are no more than about 10 mm, in some embodiments, no more than about 4 mm in their largest dimension. The other dimensions may be, for example, no more than about 2 mm, or no more than about 1 mm. In most embodiments, the largest dimension of unit 10 is the combined height of first module 11A and second module 11B with membrane 15 therebetween.

A single speaker module 11 of unit 10 may, for example, have a width (between side edges 12A) of about 100-500 micrometers and a depth (between front edge 12B and back edge 12C) of about 600-2000 micrometers. Body 12 (defined by side edges 12A, front edge 12B and back edge 12C) may be rectangular (e.g., square) with sharp or rounded corners or may have another shape, such as oval or circular. It is understood that oval and circular bodies would not have discrete side edges or front and back edges, but that oval and circular bodies would have a single wall that forms body 12. Oval and circular bodies may include breaks therein, with define an unbounded portion of the body or wall. Each wall 16, 18 may have a width of about 50-100 micrometers, and may be aligned with side edges 12A or may be spaced in therefrom. The length of walls 16, 18 may be from front edge 12B to back edge 12C or may be shorter. The height of walls 16, 18 may be about 100-300 micrometers above base 14, and the height of pole 17 above base 14 may be about 50-200 micrometers. Pole 17 may have a width of about 50-100 micrometers and a depth of about 600-2000 micrometers. Pole 17 may be rectangular (e.g., square) with sharp or rounded corners or may have another shape, such as oval or circular. In most embodiments, pole 17 has the same or similar shape as body 12. Magnet 20 is usually about 1 to 200 micrometers thick, and may be thicker or thinner than membrane 15 which supports it. In some embodiments, magnet 20 is about 1 to 100 micrometers thick. Membrane 15, between first module 11A and second module 11B and which supports magnet 20 for each module 11A, 11B, is fairly thin, typically about 1-100 micrometers thick, and in some embodiments, 1-20 micrometers thick

In use, an electrical current is applied to coil 19 of one of the elements (e.g., module 11A or module 11B), which generates a magnetic field and polarizes (e.g., charges) soft magnetic pole 17. The total magnetic field from pole 17 produces an attraction or repelling force on magnet 20 (the magnetic field illustrated in FIG. 1), which drives membrane 15 toward and away from pole 17 (e.g., down and up), thereby creating waves (e.g., sound waves). In some embodiments, an opposite electrical current can be simultaneously applied to the coil of the other element to facilitate movement of membrane 15. The sound waves resulting from the oscillating membrane 15 exit unit 10 along unbounded front edge 12B and/or back edge 12C. Through different designs of membrane 15, the bandwidth of micro-speaker unit 10 can be adjusted for a desired frequency range. The peak frequency (fₚₑₐₖ) for micro-speaker unit 10 is dependent on the thickness of membrane 15, the width of membrane 15 between walls 16, 18, and also the Young's Modulus of membrane 15. Thus, the physical design of membrane 15 affects the bandwidth and peak frequency of micro speaker unit 10. Additionally, the physical design of walls 16, 18 (i.e., their separation, their height, etc.) affects the bandwidth and peak frequency of micro speaker unit 10.

Because unit 10 is balanced, in that the structure on each side of membrane 15 is the same (i.e., first speaker module 11A is magnetically identical to second speaker module 11B), unit 10 operates more efficiently and produces a better sound quality than micro speakers where the unit is not symmetrically balanced across the oscillating membrane or diaphragm. This balanced unit is magnetically symmetric on each side of membrane 15 and in some embodiments, physically symmetric. In may be possible to form first module 11A from a different material than second module 11B and still be magnetically identical and also physically identical. However, in some embodiments, first module 11A will be magnetically, physically, and metallurgically identical to second module 11B.

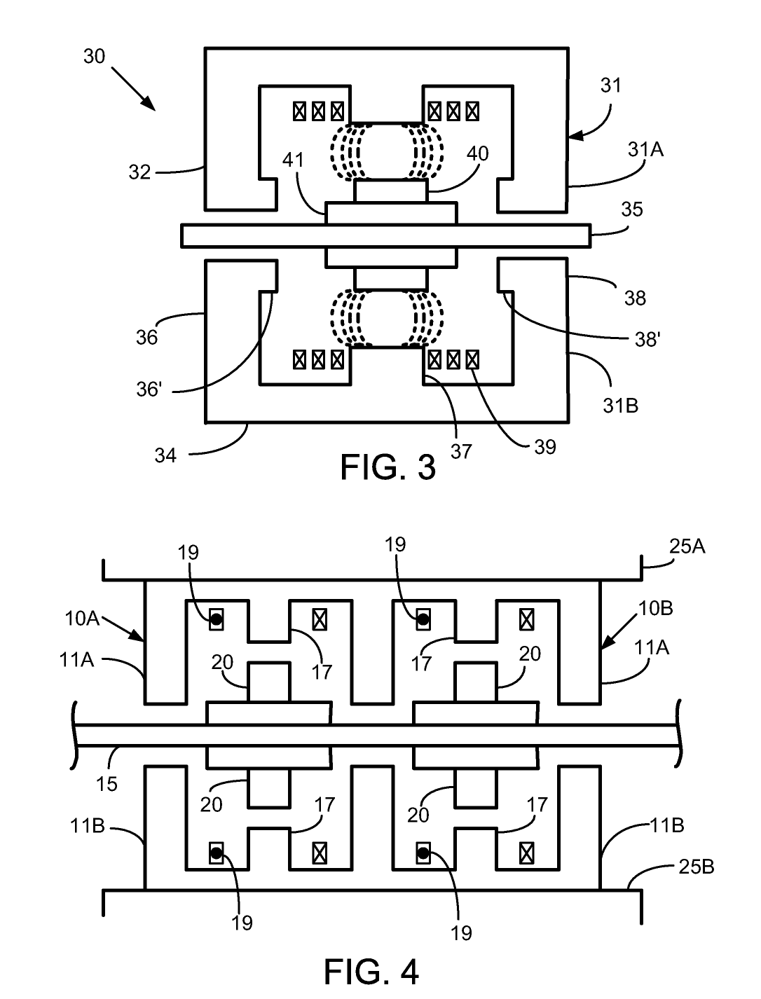

FIG. 3 illustrates another embodiment of a balanced micro magnetic speaker unit, unit 30. The various features of unit 30 are the same as or similar to the corresponding features of unit 10 in FIGS. 1 and 2, unless indicated otherwise.

Micro-speaker unit 30 is a balanced unit having two magnetically identical speaker modules or elements 31, specifically, a first speaker module or element 31A and a second speaker module or element 31B with an oscillateable membrane 35 positioned therebetween. The two magnetically identical modules 31A, 31B provide the symmetric and balanced unit 30. The following discussion is applicable to each module 31 (i.e., module 31A and module 31B), as the two elements are magnetically and structurally identical. In some embodiments, modules 31A, 31B also are metallurgically identical.

Each module 31 has a body 32 that forms the overall shape of speaker module or element 31. Body 32 has a base portion 34 with a first wall 36 opposite a second wall 38 extending from base portion 34. Centrally between walls 36, 38 is a pole 37. For unit 30, walls 36, 38 include a distal return 36′, 38′ at the end of wall 36, 38 opposite base 34. Return 36′, 38′ turns away from the edges of module 31 toward pole 37. Return 36′, 38′ decreases the open area around pole 37, and in some embodiments, may improve speaker performance. Around pole 37 on base 34 is an electrically conducting coil 39. Spaced from body 32 and preferably centered over pole 37 is a magnet 40. Magnet 40 is supported by membrane 35 and moveable in relation to pole 37, specifically toward and away from pole 37. Positioned between membrane 35 and magnet 40 is an intermediate spacer element 41, which indirectly connects magnet 40 to membrane 35.

Any of the magnetic units (e.g., unit 10 or unit 30) may be combined with at least one additional unit to provide an array. FIG. 4 illustrates an array formed of a plurality of units 10 of FIGS. 1 and 2; in FIG. 4, a first unit 10A is combined with and adjacent to a second unit 10B. Each of units 10A, 10B is the same as speaker unit 10 of FIGS. 1 and 2. Each unit 10A, 10B has first module 11A and second module 11B separated by membrane 15. Each module 11A, 11B has pole 17 with conducting coil 19 therearound and magnet 20 connected to membrane 15 opposite pole 17.

In this array, adjoining units 10A, 10B share features. For example, both units 10A, 10B utilize the same membrane 15 to support its respective magnets 20. Also, first module 11A of unit 10A and first module 11A of unit 10B share a wall. In alternate arrays, adjacent units 10A, 10B may or may not share features (e.g., walls).

To maintain the relative position of units 10A, 10B, first elements 11A of each unit 10A, 10B are on a substrate 25A and second elements 11B of each unit 10A, 10B are on a substrate 25B. Substrate 25A, 25B may be a dielectric material (for example, a polyamide or polyimide material), a metal, or other semiconductor material. Silicon (Si) is a common material for substrate 25A, 25B.

FIG. 5 illustrates a half of a larger array of micro magnetic speaker units, in this embodiment a 2 by 8 array of units similar to units 30, although FIG. 5 illustrates only half of the unit, which is an element. It is understood that in a complete array, each unit will have a magnetically identical element on each side of the membrane, often a magnetically and structurally identical element, and sometimes a magnetically, structurally and metallurgically identical unit. Array 40 of FIG. 5 includes a support substrate 42 supporting two rows 45A, 45B of micro magnetic elements. Support has front edge 42A, back edge 42B, and side edges 42C, 42D. Present at the perimeter of substrate 42 is bonding material 44. On the opposite side of rows 45A, 45B from substrate 42 is a membrane 46, which also includes bonding material 48 present at its perimeter. When assembled, bonding material 48 and bonding material 44 form a seal to encase rows 45A, 45B between substrate 42 and membrane 46. That is, membrane 46 is connected to and supported by bonding material 44 and 48. In the embodiment of FIG. 5, bonding material 44 has an opening 49, which at that location, will not sealingly bond to membrane 46.

Each row 45A, 45B has eight magnetic elements 50. Each element 50 is similar to module 31B of FIG. 3, which is half of unit 30. Element 50 has a front edge 50A, a back edge 50B, and side edges 50C, 50D. Element 50 has a body 52 that forms a base and side walls that house a pole with a coil therearound, similar to module 31B of FIG. 3. Spaced from the pole and coil is a magnet, which is supported by membrane 46 via an intermediate spacer layer. In this embodiment, as for module 31B, front edge 50A and back edge 50B are unbounded whereas side edges 50C, 50D are bounded by side walls. In use of array 40, the sound waves resulting from the oscillating membrane 46 exit element 50 along unbounded front edge 50A and/or unbounded back edge 50B.

For an array of units, such as array 40 of FIG. 5, in most embodiments, the largest dimension is the width or length across the array of units. For example, an array of units, for example, a 2 by 8 array of units, may have a width or length (e.g., between side edges 42C, 42D) of about 4 mm and a depth (e.g., between front edge 42A to back edge 42B) of about 2 mm. Larger arrays may have larger dimensions. An example of an overall height for an array of units, which has two identical speaker modules or elements with the membrane therebetween, is about 2 mm.

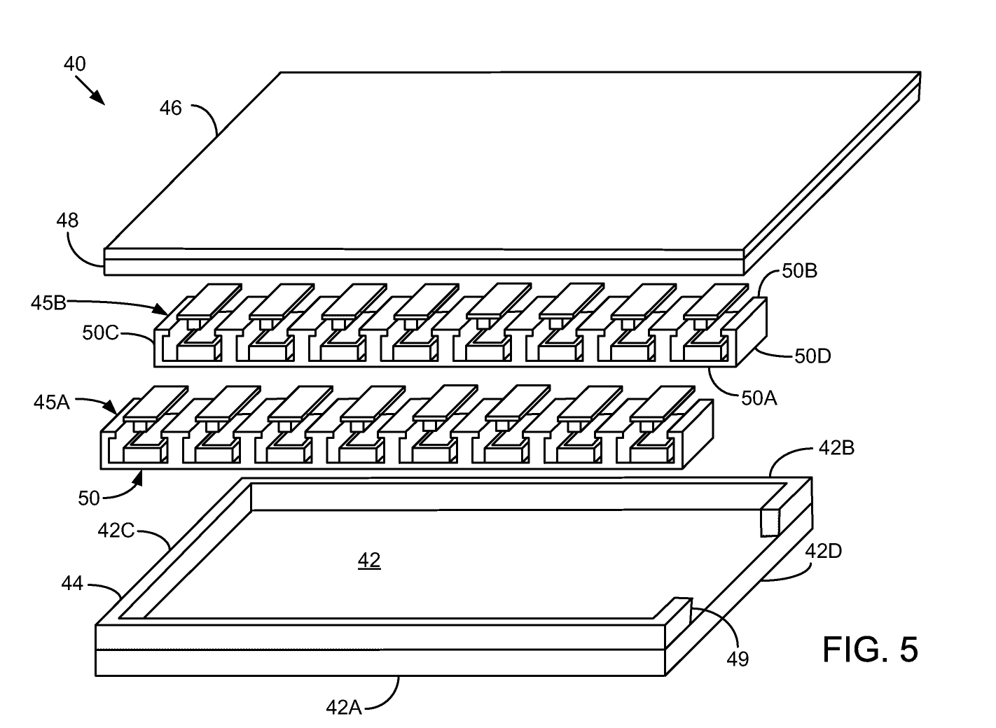

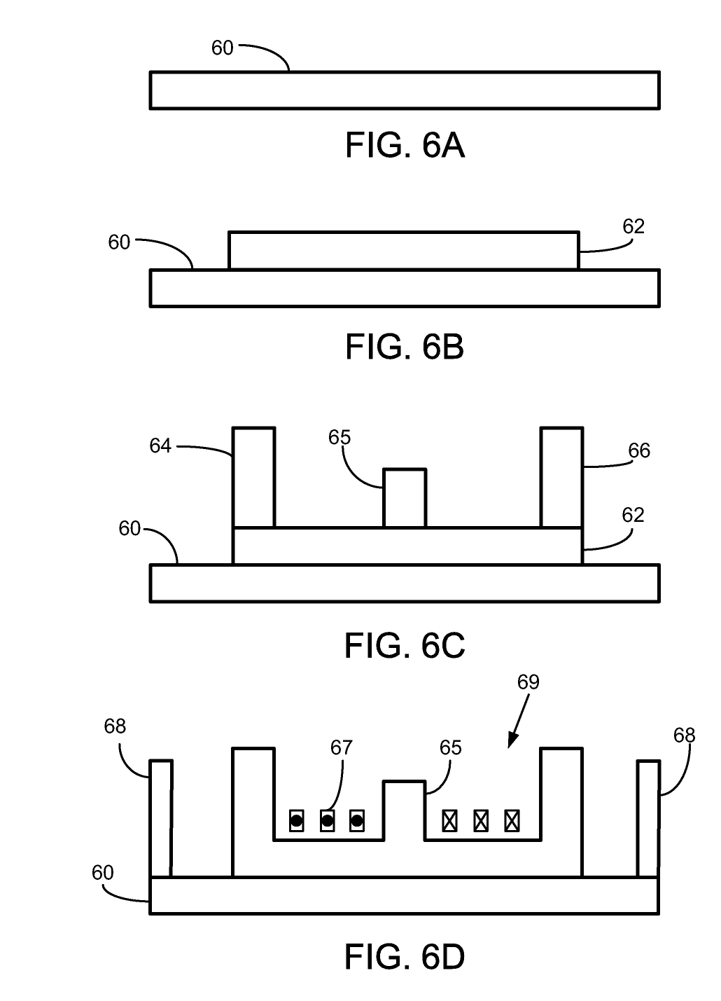

One general method of making a balanced micro magnetic speaker, such as speaker unit 10 of FIGS. 1 and 2, is illustrated in FIGS. 6A-6D, 7A-7E, 8 and 9.

In FIGS. 6A through 6D, a first portion of a micro-speaker element is step-wise manufactured. The element manufactured herein is similar to the lower portion of speaker module 11B of unit 10 of FIGS. 1, 2 and 4.

A starting support 60 is illustrated in FIG. 6A; support 60 is a carrier or substrate, such as substrate 25B of FIG. 4, for the eventual micro device. In many embodiments, substrate 60 is an inert material, such as silicon, optionally coated with a dielectric material, such as silicon dioxide. In FIG. 6B, applied onto substrate 60 is a layer of soft ferromagnetic material 62, which will form the eventual magnetic material body portion (e.g., body portion 12 of module 11B). Soft ferromagnetic material 62 may be plated (e.g., electroplated), deposited (e.g., CVD, PVD, sputtered), or screen printed from a slurry of ferromagnetic particles in a binder material. Applied over soft ferromagnetic material 62, in FIG. 6C, is additional soft ferromagnetic material that forms columns 64, 66 which will form the eventual walls and pole column 65 that will form the eventual pole (e.g., walls 16, 18 and pole 17 of module 11B). Columns 64, 66 and pole column 65 may be formed simultaneously or sequentially. The soft ferromagnetic material of columns 64, 66 and pole column 65 may be the same or different than soft ferromagnetic material 62, and may be plated (e.g., electroplated), deposited (e.g., CVD, PVD, sputtered), or screen printed from a slurry of ferromagnetic particles in a binder material. In some embodiments, material 62 and columns 64, 66 and pole column 65 may be applied in the same step rather than in separate sequential steps.

An electrically conductive coil 67 is positioned around pole column 65 in FIG. 6D. Coil 67 may be previously produced and physically placed around pole column 65, or coil 67 may be fabricated (e.g., plated or deposited) around pole column 65. The result is first or lower portion 69. Optionally, bonding material 68 may be positioned on either or both sides of columns 64, 66; bonding material 68 may be used in later processing steps to join element 68 with a corresponding element.

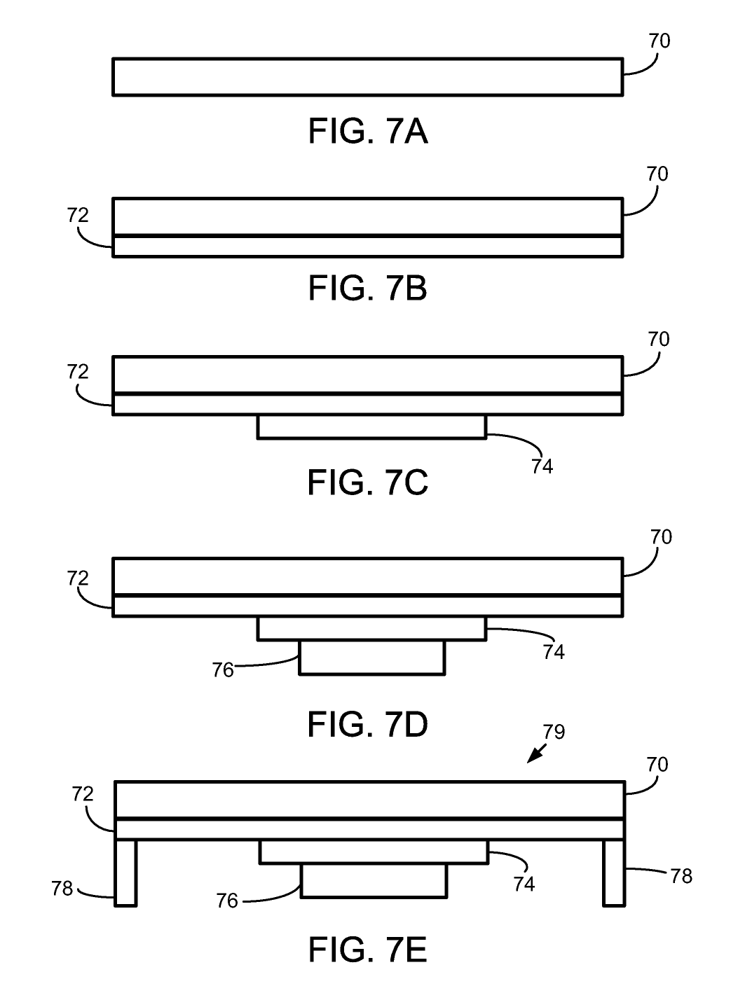

In FIGS. 7A through 7E, a second portion of a micro element is step-wise manufactured. If referring to module 11B of unit 10 of FIG. 1, this second portion is the top or upper portion of module 11B and includes membrane 15.

A starting non-magnetic support material 70 is illustrated in FIG. 7A. In many embodiments, non-magnetic support material 70 is an inert material, such as silicon, optionally coated with a dielectric material, such as silicon dioxide. In FIG. 7B, a thin film 72 is formed on support material 70. In most embodiments, thin film 72 is non-magnetic and has a thickness of no more than about 200 micrometers. Thin film 72 will form the eventual membrane (e.g., membrane 15) of the speaker unit. In FIG. 7C, applied onto thin film 72 is a layer of material 74, such as soft ferromagnetic material, which will form the eventual (and optional) intermediate spacer element (e.g., intermediate spacer element 21 between membrane 15 and magnet 20 of module 11B of FIG. 1). A hard or permanent ferromagnetic material 76, which will form the eventual magnet of the speaker (e.g., magnet 20 of module 11B) is applied over material 74 in FIG. 7D. Any or all of thin film 72, material 74 and ferromagnetic material 76 may be plated, deposited, screen printed, or formed otherwise. Optionally, bonding material 78 may be positioned on either or both sides of ferromagnetic material 76; bonding material 78 may be used in later processing steps to join the resulting upper portion 79 of FIG. 7E with lower portion 69 of FIG. 6D.

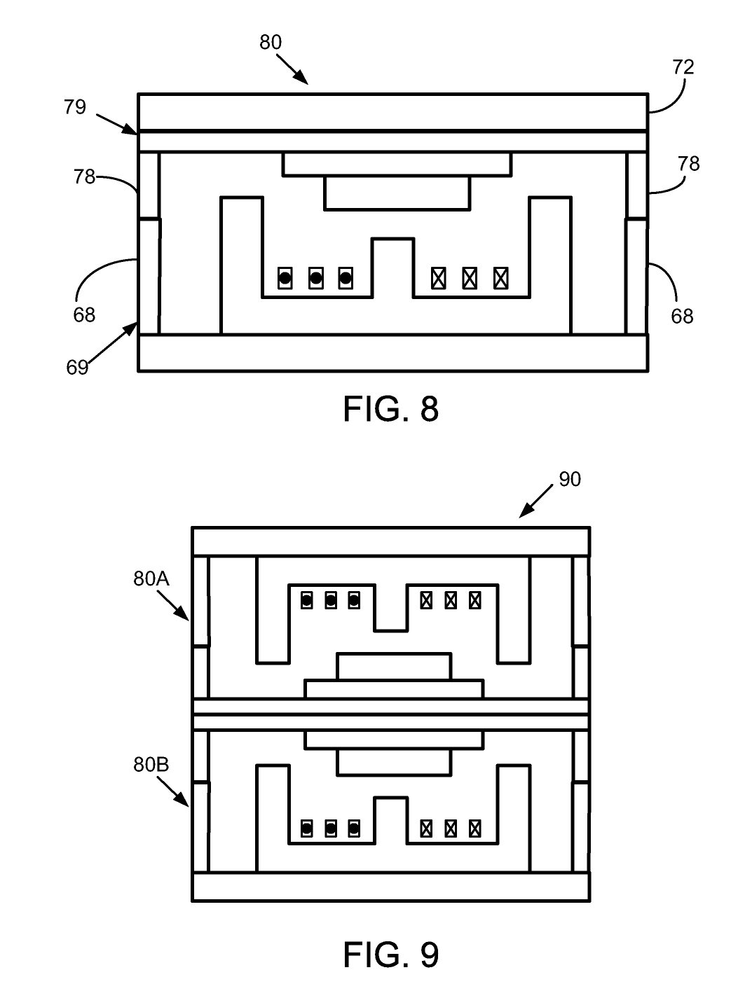

In FIG. 8, lower portion 69 from FIG. 6D is joined to upper portion 79 from FIG. 7E via bonding material 68 and bonding material 78. This may be done by wafer bonding, under the application of heat and/or pressure. In some embodiments, an adhesive, metal or solder material may be used to facilitate the bonding. The resulting element 80 is similar to micro speaker module 11B of FIG. 1. After bonding of lower portion 69 to upper portion 79, substrate 72 may be removed (e.g., etched away).

In FIG. 9, two elements 80, specifically first element 80A and second element 80B are combined to form one unit 90. For example, first element 80A may be similar to first speaker module 11A of FIG. 1, second element 80B may be similar to second module 11B of FIG. 1, and the resulting unit 90 is similar to unit 10 of FIG. 1.

Alternate embodiments of micro speaker units and arrays may be made by similar methods. To form an array such as illustrated in FIG. 4, two element lower portions would be made, typically simultaneously, in a method similar to that illustrated in FIGS. 6A-6D and two element upper portions would be made, typically simultaneously, in a manner similar to that illustrated in FIGS. 7A-7E. The resulting structures would be joined in a manner similar to that illustrated in FIG. 8 to form two elements, and two elements would be joined in a manner similar to that illustrated in FIG. 9 to form an array of two units. To form an array such as illustrated in FIG. 5, the methods would be similar, except the portions and elements formed would be present as 2 by 8 arrays. It is understood that the micro magnetic speakers of this disclosure, whether a single unit or an array, could be made by any number of alternate methods.

Thus, embodiments of the MICRO MAGNETIC SPEAKER DEVICE WITH BALANCED MEMBRANE are disclosed. The implementations described above and other implementations are within the scope of the following claims. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. A micro magnetic speaker unit comprising:
a first speaker module, a second speaker module, and a membrane therebetween;
each speaker module comprising a body, a pole comprising a soft magnetic material, an electrically conductive coil positioned around the pole, and a permanent magnet connected to the membrane,
wherein the first speaker module and the second speaker module are magnetically identical.

2. The micro magnetic speaker unit of claim 1 wherein the first speaker module and the second speaker module are structurally identical.

3. The micro magnetic speaker unit of claim 2 wherein the first speaker module and the second speaker module are metallurgically identical.

4. The micro magnetic speaker unit of claim 1, wherein for each speaker module, the permanent magnet is centered over the pole.

5. The micro magnetic speaker unit of claim 1 wherein the body of each module is rectangular.

6. The micro magnetic speaker unit of claim 5, wherein the body of each speaker module comprises at least one unbounded side.

7. The micro magnetic speaker unit of claim 4, wherein the body of each speaker module comprises two unbounded sides.

8. The micro magnetic speaker unit of claim 1 wherein the body of each module comprises walls having a distal return.

9. A micro magnetic speaker unit comprising:
a first speaker module comprising a first body having two opposite unbounded sides and two opposite walled sides, a first pole positioned between the unbounded sides and the walled sides, a first electrically conductive coil positioned around the first pole, and a first permanent magnet spaced from the first pole;
a second speaker module comprising a second body having two opposite unbounded sides and two opposite walled sides, a second pole positioned between the unbounded sides and the walled sides, a second electrically conductive coil positioned around the second pole, and a second permanent magnet spaced from the second pole; and
a membrane extending between the first speaker module and the second speaker module, the membrane supporting the first magnet on a first side and supporting the second magnet on a second side.

10. The micro magnetic speaker unit of claim 9 wherein the first speaker module and the second speaker module are magnetically identical.

11. The micro magnetic speaker unit of claim 10 wherein the first speaker module and the second speaker module are structurally identical.

12. The micro magnetic speaker unit of claim 11 wherein the first speaker module and the second speaker module are metallurgically identical.

13. The micro magnetic speaker unit of claim 9, wherein the walled sides of each speaker module include a distal return extending toward the pole.

14. The micro magnetic speaker unit of claim 9 wherein the first speaker module further comprises a first intermediate spacer element between the first permanent magnet and the membrane and the second speaker module further comprises a second intermediate spacer element between the second permanent magnet and the membrane.

15. A micro speaker array comprising a plurality of micro magnetic speaker units, each unit comprising:
a first speaker module and a second speaker module, with a membrane therebetween;
each speaker module comprising a body, a pole comprising a soft magnetic material, an electrically conductive coil positioned around the pole, and a permanent magnet connected to the membrane.

16. The micro speaker array of claim 15 wherein the first speaker module and the second speaker module of each unit are magnetically identical.

17. The micro speaker array of claim 16 wherein the first speaker module and the second speaker module of each unit are structurally identical.

18. The micro speaker array of claim 15, wherein the first speaker module and the second speaker module of each unit have a rectangular body with at least one unbounded side.

19. The micro speaker array of claim 18, wherein the first speaker module and the second speaker module of each unit have two opposite unbounded sides.

20. The micro speaker array of claim 19 wherein the unbounded sides of each unit are aligned.
